(19) United States
(12) Patent Application Publication
(10) Pub. No.: US 2016/0172892 A1
(43) Pub. Date: Jun. 16, 2016

(54) WIRELESS POWER SOURCE WITH PARALLEL RESONANT PATHS

(71) Applicant: MEDIATEK SINGAPORE PTE. LTD, Fusionopolis Walk (SG)

(72) Inventors: Anand SATYAMOORTHY, Somerville, MA (US); Patrick Stanley RIEHL, Cambridge, MA (US); Agasthya AYACHIT, San Jose, CA (US)

(73) Assignee: Mediatek Singapore Pte. Ltd., Fusionopolis Walk (SG)

(21) Appl. No.: 14/907,063

(22) PCT Filed: Aug. 5, 2014
(86) PCT No.: PCT/US2014/049675

§ 371 Date: Jan. 22, 2016

Related U.S. Application Data
(60) Provisional application No. 61/862,585, filed on Aug. 6, 2013.

(51) Int. Cl. H02J 7/02; H02J 7/04

(52) U.S. Cl. CPC H02J 7/025; H02J 7/04

(57) ABSTRACT

A wireless charger for charging multiple devices is provided that includes one or more drive coils that are coupled to a drive amplifier. A plurality of repeater coils are coupled to the one or more drive coils. One or more receiver coils are coupled to the repeater coils. The one or more repeater coils are tuned such that they are only resonant when the one or more receiver coils are in close proximity.

### PRIORITY INFORMATION

This application claims priority from provisional application Ser. No. 61/862,585 filed Aug. 6, 2013, which is incorporated herein by reference in its entirety.

### BACKGROUND OF THE INVENTION

The invention is related to the field of charging devices, and in particular to a multiple-device wireless charger with a large charging area but minimal active circuits

Conventional ways to design a multiple device charger are (a) to use many coils with many active devices to selectively activate them or (b) to use a single large coil to cover the whole charging area.

Approach (a) can provide good efficiency because the coils which are selectively activated can have a high coupling factor. High coupling factor leads to high efficiency. However, approach (a) requires at least one active device per coil, thus the complexity, cost, size and weight of the solution increase with charging area.

Approach (b) tends not to provide good efficiency because the arrangement in which a large source coil coupled to a small receiver coil has a low coupling factor. Low coupling factors imply a low efficiency. Another problem with approach (b) is that, when the source coil is large compared to the receiver device, any metal in the receiver device will affect the inductance of the source coil. This effect is called metal detuning.

In the prior art, repeaters (passive resonators) have been used to improve coupling between source and receiver coils separated by a large distance, or with a large relative size ratio. In this invention, one use multiple parallel repeaters to improve the coupling between source and receiver coils. In addition, we use the metal detuning effects of receivers to improve the selectivity of power transfer.

### SUMMARY OF THE INVENTION

According to one aspect of the invention, there is provided a wireless charger for charging multiple devices: The wireless charger includes one or more drive coils that are coupled to a drive amplifier. A plurality of repeater coils are coupled to the one or more drive coils. One or more receiver coils are coupled to the repeater coils. The one or more repeater coils are tuned such that they are only resonant when the one or more receiver coils are in close proximity.

According to another aspect of the invention, there is provided a method of forming a wireless charger for charging multiple devices. The method includes providing one or more drive coils that are coupled to a drive amplifier. Moreover, the method includes positioning a plurality of repeater coils that are coupled to the one or more drive coils. Furthermore, the method includes positioning one or more receiver coils that are coupled to the repeater coils. The one or more repeater coils are tuned such that they are only resonant when the one or more resonant coils are in close proximity.

### BRIEF DESCRIPTION OF THE DRAWINGS

FIG. 1 is a schematic diagram illustrates a generic circuit model of a wireless power system;

FIG. 2 is a schematic diagram illustrating an example of a standard coil arrangement;

FIG. 3 is a schematic diagram illustrating a model of the coil arrangement described in FIG. 2;

FIG. 4 is schematic diagram illustrating a 1:2 coupled magnetic system used in accordance with the invention;

FIG. 5 is a schematic diagram illustrating a model of the coil arrangement described in FIG. 4;

FIG. 6 is a schematic diagram illustrating a 1:2 parallel coupled magnetic system used in accordance with the invention; and

FIG. 7 is a schematic diagram illustrating a model of the coil arrangement described in FIG. 6.

### DETAILED DESCRIPTION OF THE INVENTION

The invention describes a technique to design a multiple-device wireless charger with a large charging area but minimal active circuits. The invention deliberately tunes the repeaters off resonance, such that they will only be in tune when the receiver metal is present.

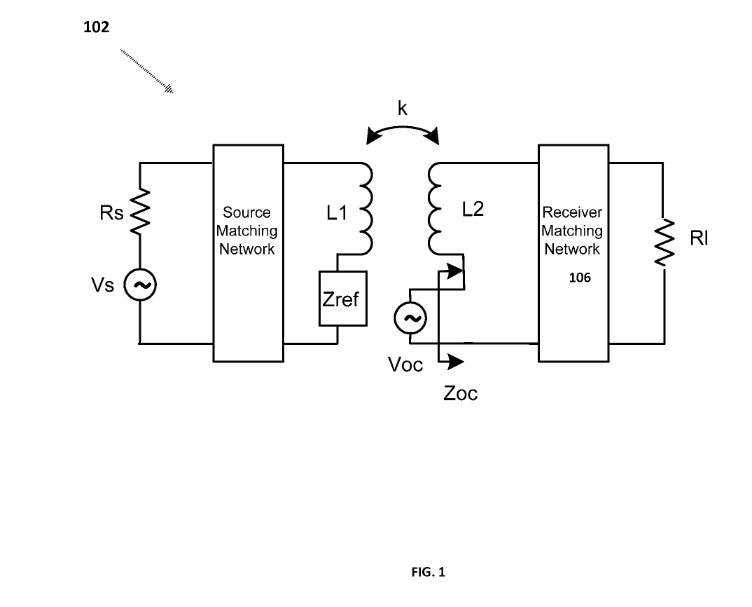

FIG. 1 shows a resonant wireless power (RWP) system 102. There are two complex impedances that can be used to describe most of the important aspects of a RWP system: the open-circuit impedance Zoc and the reflected impedance Zref. Mutual inductance, or coupling, between the source coil L1 and receiver coil L2 can be modeled in a number of different ways. Coupling can be expressed as a mutual inductance M, or a unitless coupling coefficient k. The mutual inductance M, the coupling coefficient k and the coil inductances L1 and L2 obey the relationship expressed by Eq. 1.

M=k\sqrt{L₁L₂} Eq. 1

In this case, the coupling k is modeled as a current-controlled voltage source in series with the receiver coil L2. The impedance seen by this voltage source Voc, which includes the coil L2, matching network 106 and load (rectifier, dc/dc, load current), is Zoc. On the source side, when coupling is present, one can model the effect of the coupling as an impedance in series with the source coil L1 called Zref, the reflected impedance. Both the open-circuit impedance and the reflected impedance are complex quantities—they have real (resistive) and imaginary (reactive) components. For a 1:1 RWP system, the reflected impedance is related to the open-circuit impedance by Eq. 2.

$${Z}_{ref} = \frac{{( ω M )}^{2}}{{Z}_{oc}} \qquad Eq . 2$$

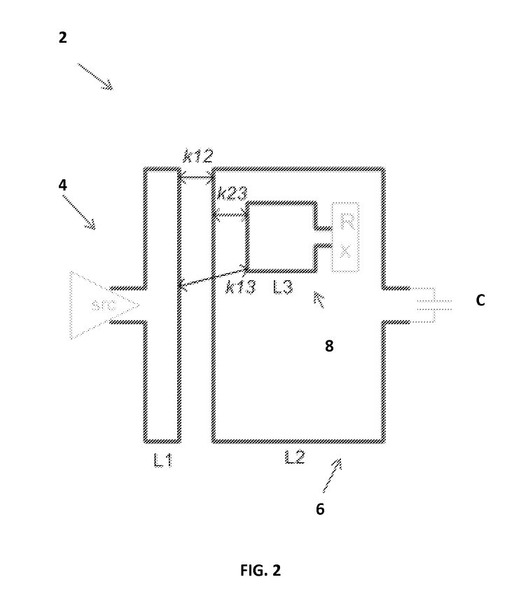

FIG. 2 represents an example of a three-coil wireless power system 2. A source amplifier labeled “src” drives a drive coil L1 to form a transmitter 4. This drive coil L1 is coupled to a repeater coil 6 having a coil inductance L2 through coupling factor k12. The repeater 6 is coupled to a receiver RX via a receiver coil L3 through coupling k23. A direct coupling k13 also exists but this can be neglected. The repeater L2 is directly connected to a capacitor C.

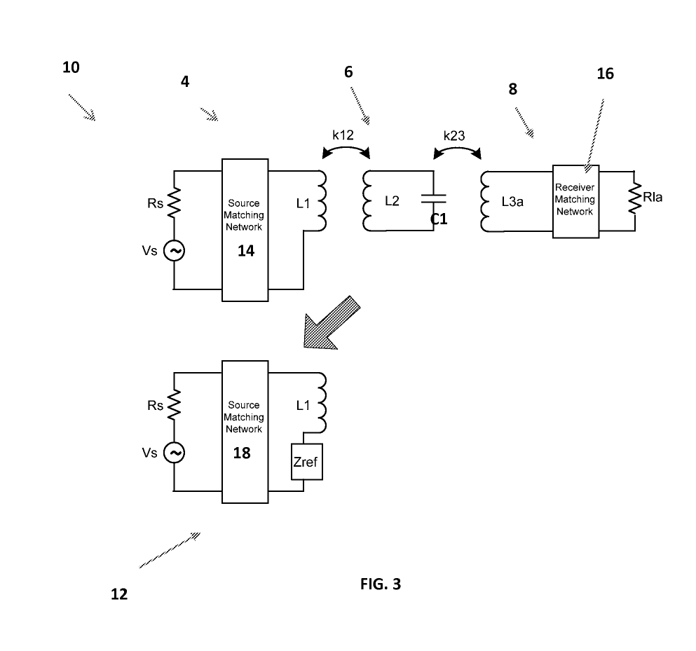

FIG. 3 shows a model of the standard coil arrangement described in FIG. 2. The transmitter 4 is modeled as having a resistance Rs, a variable voltage source Vs, a source matching network 4, and an inductance L1. The transmitter 4 is magnetically coupled to a repeater 6 through coupling k12. The repeater 6 is modeled as having an inductance L2 that is coupled to a capacitor C1. The repeater 6 is magnetically coupled to a receiver 8 through coupling k23. The receiver 8 is modeled with an inductance L3a, a receiver matching network 16, and resistance R1a. An equivalent circuit arrangement can be constructed to simply model the loading of the repeater 6 and the receiver 8 on the transmitter 4. The equivalent circuit arrangement 12 include the voltage source Rs, a source matching network 18, inductance L1, and a reflected impedance Zref associated with repeater 6 and receiver 8.

In practice, the receiver 8 is typically part of an electronic device such as a mobile phone that is partially constructed from conducting materials. As such, the metal in the electronic device will interact with the coupled coils, affecting the tuning of the resonant system. In order to counteract this effect, it is possible to deliberately off-tune the repeater, such that it is only resonant when the receiver with associated electronic device is in close proximity.

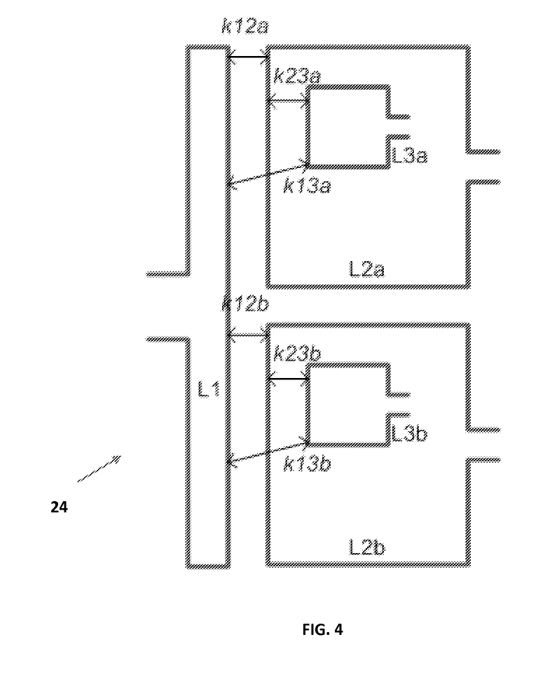

FIG. 4 is a schematic diagram illustrating a 1:2 coupled magnetic system 24. In particular, the drive coil L1 is now coupled to two repeaters, L2a and L2b. Each of these repeaters may or may not be coupled to a receiver coil L3a, L3b, depending on the use case of the charger. The repeaters L2a and L2b are tuned such that they are only resonant when the receiver is present. This provides some selectivity for where energy is stored in the system. The energy stored in repeaters that do not have a receiver present is minimal because they are off-tuned. This minimizes losses in the system because energy stored in repeaters not coupled to a receiver is eventually dissipated as heat. Direct couplings k13a and k13b should be minimized and are neglected in further analysis.

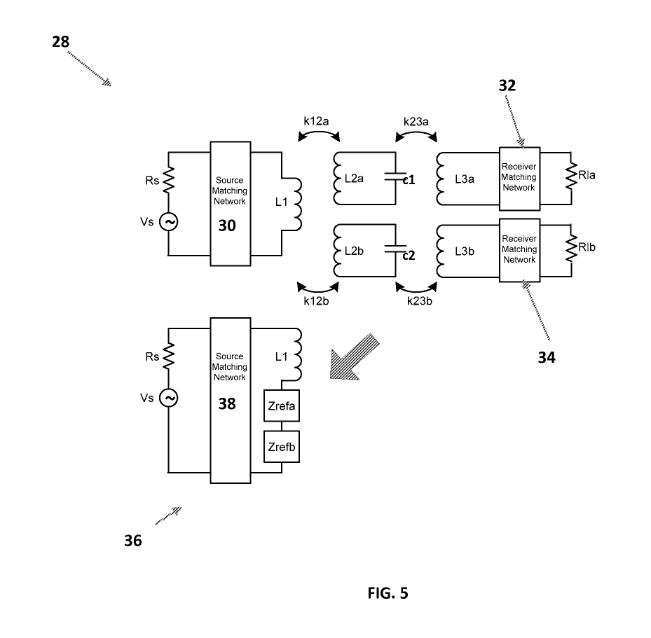

FIG. 5 shows a model of the coil arrangement described in FIG. 4. The source coil L1 is modeled as being connected to a resistance Rs and a variable voltage source Vs representing the drive amplifier and a source matching network 30. The source coil L1 is magnetically coupled to two repeater coils L2a and L2b through coupling coefficients k12a and k12b, respectively. The repeater coils L2a and L2b are coupled to capacitors C1 and C2. Each repeater coil is magnetically coupled to a receiver coil in this example. Repeater coil L2a is magnetically coupled to receiver coil L3a through coupling coefficient k23a. Repeater coil L2b is magnetically coupled to receiver coil L3b through coupling coefficient k23b. The coils L3a, L3b are both are modeled as being connected to receiver matching networks 32, 34, and resistances R1a and R1b. As in the example of FIG. 3, an equivalent circuit arrangement can be defined that simply models the loading of the repeaters and receivers on the source amplifier.

The equivalent circuit arrangement 36 include a voltage source Vs, source resistance Rs, matching network 38, inductance L1, and reflected impedances Zrefa and Zrefb associated with the direct couplings k12a, k12b, k23a, k23b. The reflected impedances Zrefa, Zrefb appear in series with L1. The repeater coils L2a and L2b are tuned such that whichever repeater is coupled to a receiver at a given time presents a higher impedance to the drive amplifier. This arrangement is a good choice if the drive amplifier behaves like a current source.

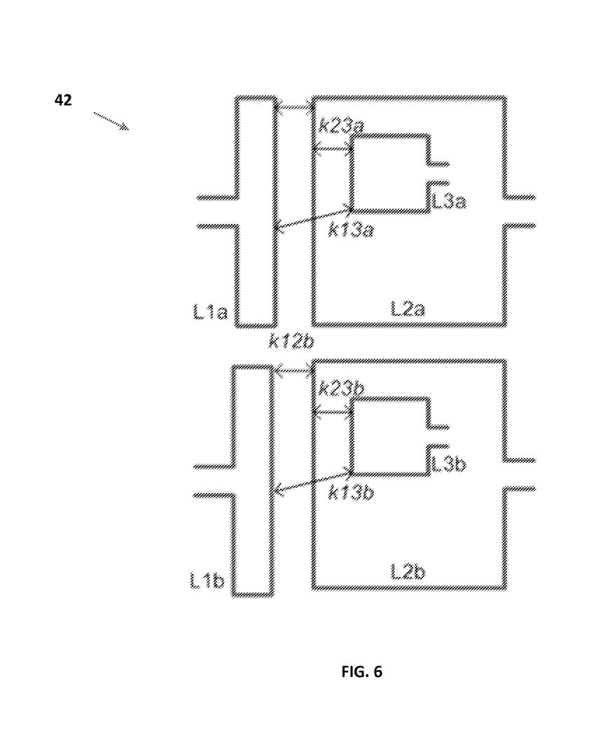

FIG. 6 shows a 1:2 parallel coupled magnetic system 42. In this embodiment, the source amplifier (not shown) drives two source coils, L1a and L1b in a parallel arrangement. The two source coils L1a and L1b are coupled to repeaters L2a and L2b through coupling coefficients k12a and k12b. Each repeater may or may not be coupled to a receiver device L3a and L3b through coupling coefficients k23a and k23b. As in the first embodiment of FIG. 4, the resonators L2a and L2b are tuned such that they are only resonant when there is a receiver in close proximity. This results in less energy stored in repeaters that are not coupled to receivers.

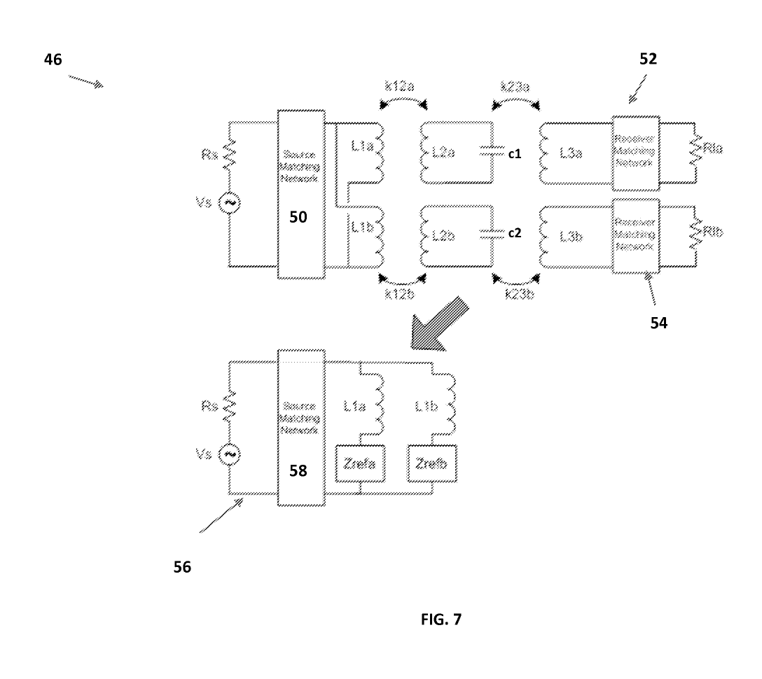

FIG. 7 shows a model of the coil arrangement described in FIG. 6. The source coils L1a and L1b are connected in a parallel arrangement. The source coils L1a and L1b are modeled as being connected to a resistance Rs, a variable voltage source Vs, a source matching network 50. The repeater coils L2a and L2b are coupled to capacitors C1 and C2, respectively. The coils L3a, L3b are both are modeled as being connected to receiver matching networks 52, 54, and resistance R1a and R1b. As in the example of FIG. 3, an equivalent circuit arrangement can be defined that simply models the loading of the repeaters and receivers on the source amplifier. The equivalent circuit arrangement 56 includes a source resistor Rs and voltage source Vs coupled to parallel inductances L1a and L1b and reflected impedances Zrefa and Zrefb associated with direct couplings k12a, k12b, k23a, k23b.

The power paths corresponding to L2a/L3a and L2b/L3b are driven in parallel. In terms of the circuit performance, the off-tuned repeaters present a high reflected reactance to the primary coils. The result is that branches of the power path with no receiver appear as a high impedance to the source amplifier compared to branches with a receiver. This results in more power steered to the branches that are in active use. This embodiment is a good choice if the source amplifier behaves like a voltage source.

Although the present invention has been shown and described with respect to several preferred embodiments thereof, various changes, omissions and additions to the form and detail thereof, may be made therein, without departing from the spirit and scope of the invention.

What is claimed is:

1. A wireless charger for charging multiple devices comprising:
one or more drive coils that are coupled to a drive amplifier;
a plurality of repeater coils that are coupled to the one or more drive coils; and
one or more receiver coils that are coupled to said repeater coils, the one or more repeater coils being tuned such that they are only resonant when the one or more receiver coils are in close proximity.

2. The wireless charger of claim 1, wherein the drive amplifier is coupled to a plurality of drive coils in parallel, each of which is coupled to at least one repeater coil, each of the at least one repeater coil is coupled to the one or more receiver coils

3. The wireless charger of claim 2, wherein the coils are tuned such that the drive coil that is coupled to a receiver at a given time presents a lower impedance to the amplifier, thus drawing more current.

4. The wireless charger of claim 1, wherein the repeater coils are tuned so as to present a higher impedance to the drive amplifier when coupled to a receiver coil.

5. A method of forming a wireless charger for charging multiple devices comprising:
providing one or more drive coils that are coupled to a drive amplifier;
positioning a plurality of repeater coils that are coupled to the one or more drive coils; and
positioning one or more receiver coils that are coupled to said repeater coils, the one or more repeater coils being tuned such that they are only resonant when the one or more resonant coils are in close proximity.

6. The method of claim 5, wherein the drive amplifier is coupled to a plurality of drive coils in parallel, each of which is coupled to at least one repeater coil, each of the at least one repeater coil is coupled to the one or more receiver coils

7. The method of claim 6, wherein the coils are tuned such that the drive coil that is coupled to a receiver at a given time presents a lower impedance to the amplifier, thus drawing more current.

8. The method of claim 5, wherein the repeater coils are tuned so as to present a higher impedance to the drive amplifier when coupled to a receiver coil.
